(19) United States
(12) Patent Application Publication
(10) Pub. No.: US 2003/0102350 A1
(43) Pub. Date: Jun. 5, 2003

(54) Washer receiving cylinder of pneumatic nail gun with washer retaining mechanism

(76) Inventors: Hsien Nung Liu, Taipei (TW); Chien Chi Chou, Taipei (TW)

Correspondence Address: Hsien Nung Liu, 235 Chung-Ho, Box 8-24, Taipei, TW

(21) Appl. No.: 10/006,736

(22) Filed: Dec. 5, 2001

(51) Int. Cl. B25C 7/00

(52) U.S. Cl. 227/18

(57) ABSTRACT

A washer feeding device attached to a nail gun is provided. The washer feeding device comprises a hollow cylindrical washer receiving cylinder having a plurality of washers stacked therein. The washer receiving cylinder comprises the following elements. A ring-like first stop member is inwardly extended from the top edge. The inner diameter of the first stop member is smaller than the diameter of the washer by a predetermined value. A flexible second stop member is temporarily snapped to the bottom. A bias mechanism on the washer receiving cylinder serves for pressing the topmost washer downwardly; and a pneumatic delivery mechanism serves for pushing the bottommost washer into the nail gun. The washers are prevented from dropping from either end of the washer receiving cylinder in storage. Also, the washers are free to leave the washer receiving cylinder through the second stop member in operation.

### FIELD OF THE INVENTION

The present invention relates to pneumatic nail guns and more particularly to a washer receiving cylinder of a pneumatic nail gun with washer retaining mechanism.

### BACKGROUND OF THE INVENTION

U.S. patent application Ser. Nos. 09/628,240 and 09/819,485 entitiled “Nail Gun With Washer Feeding Device” filed by the present applicant are aimed at providing improved nail guns for enhancing the fixing capability of nail and washer combination. The inventor of the present invention finds that washer may be dropped from either end of the washer receiving cylinder undesirably in any of above mentioned applications while in use. Thus, further improvement with respect to washer receiving cylinder is necessary.

### SUMMARY OF THE INVENTION

It is an object of the present invention to provide a washer feeding device attached to a nail gun. The washer feeding device comprises a hollow cylindrical washer receiving cylinder having a plurality of washers stacked therein, the washer receiving cylinder comprising a ring-like first stop member inwardly extended from the top edge wherein the inner diameter of the first stop member is smaller than the diameter of the washer by a predetermined value and a flexible second stop member temporarily snapped to the bottom; a bias mechanism on the washer receiving cylinder for pressing the topmost washer downwardly; and a pneumatic delivery mechanism for pushing the bottommost washer into the nail gun. The washers are prevented from dropping from either end of the washer receiving cylinder in storage. Also, the washers are free to leave the washer receiving cylinder through the second stop member in operation.

The above and other objects, features and advantages of the present invention will become apparent from the following detailed description taken with the accompanying drawings.

### BRIEF DESCRIPTION OF THE DRAWINGS

FIG. 1 is an exploded perspective view showing a part of a first preferred embodiment of the washer receiving cylinder of a nail gun according to the invention;

FIG. 2 is a perspective view of the washer shown in FIG. 1;

FIG. 3 is a perspective view of FIG. 1;

FIG. 4 is a perspective view of a second preferred embodiment of the washer receiving cylinder of a nail gun according to the invention;

FIG. 5 is a perspective view of a third preferred embodiment of the washer receiving cylinder of a nail gun according to the invention;

FIG. 6 is a partial side view showing the washer in the receiving cylinder is dropped on the delivery mechanism; and

FIG. 7 is similar to FIG. 6 where the washer of the present invention is pushed to a nail outlet and is penetrated by a nail.

### DETAILED DESCRIPTION OF THE PREFERRED EMBODIMENTS

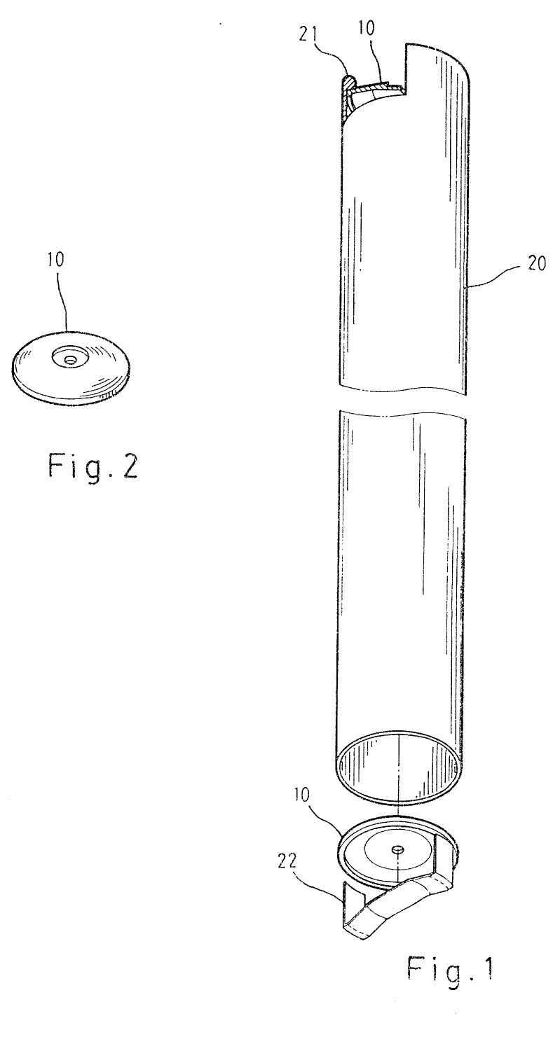

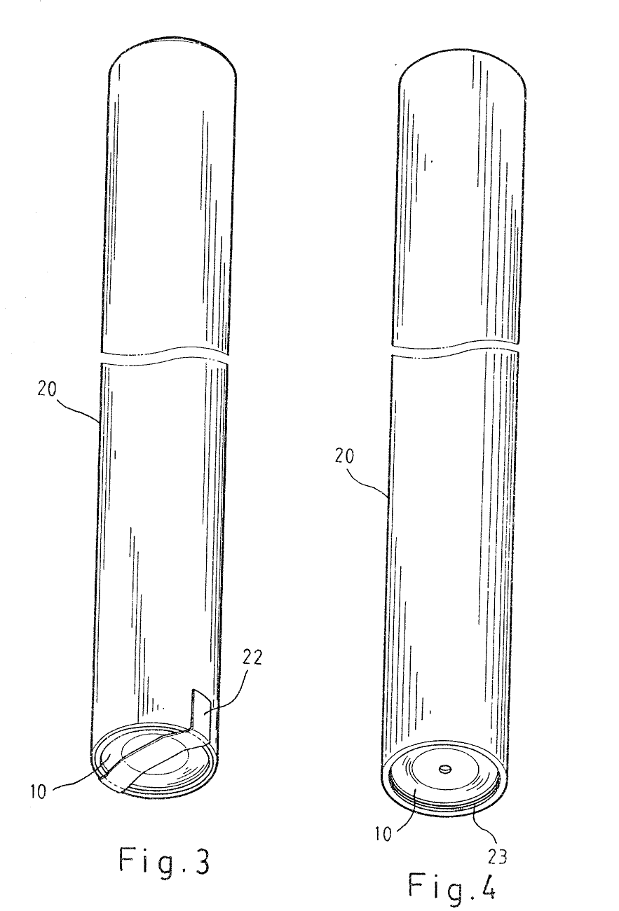

Referring to FIGS. 1 to 3, a first preferred embodiment of a hollow cylindrical washer receiving cylinder 20 mounted on a nail gun (not shown) is illustrated. A plurality of washers 10 are stacked longitudinally in the washer receiving cylinder 20. The washer receiving cylinder 20 comprises a first stop member 21 slightly inwardly extended from the top edge (e.g., a ring-like member) wherein the inner diameter of the first stop member 21 is slightly smaller than the diameter of washer 10 and a flexible second stop member 22 (e.g., a U-shaped metal piece) temporarily snapped to the bottom (i.e., having both ends snapped to the circumferential surfaces of the washer receiving cylinder 20). Both stop members 21 and 22 can prevent the stored washers 10 from dropping therefrom undesirably. It is required to simply remove the second stop member 22 prior to mounting washer receiving cylinder 20 on the nail gun. Thus, it is ready to be used.

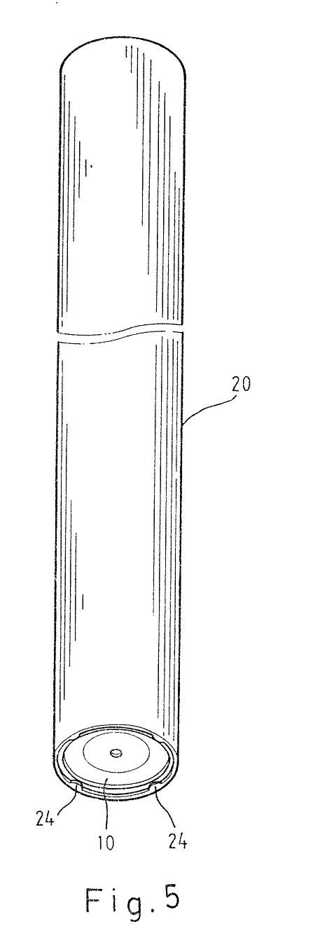

FIG. 4 is a perspective view of a second preferred embodiment of washer receiving cylinder 20 of the present invention. The difference between first and second embodiments is that a flexible third stop member 23 is slightly inwardly extended from the bottom edge (e.g., a ring-like member) wherein the inner diameter of third stop member 23 is slightly smaller than the diameter of the washer 10. It is contemplated that third stop member 23 may be one of a variety of arrangements as long as the washer 10 is prevented from dropping undesirably while without blocking the washer 10 from leaving the washer receiving cylinder 20 in operation.

FIG. 5 is a perspective view of a third preferred embodiment of the washer receiving cylinder 20. The difference between the second and third embodiments of the present invention is that a plurality of equally spaced flexible fourth stop members 24 are slightly inwardly extended from the bottom edge (i.e., projections). It is also contemplated that the fourth stop members 24 may prevent the washer 10 from dropping undesirably while without blocking the washer 10 from leaving the washer receiving cylinder 20 in operation.

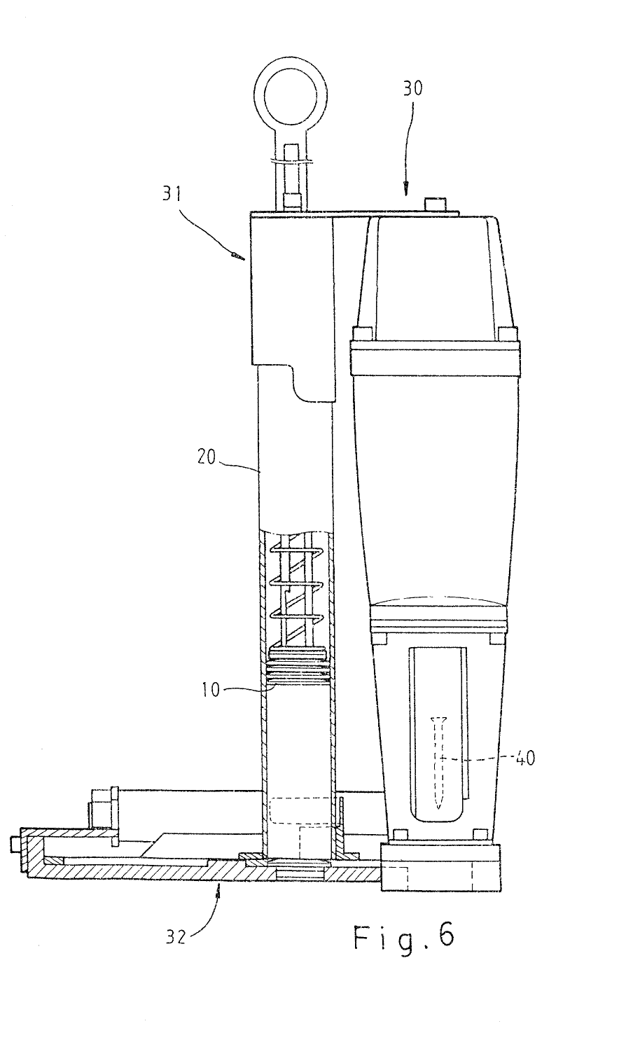

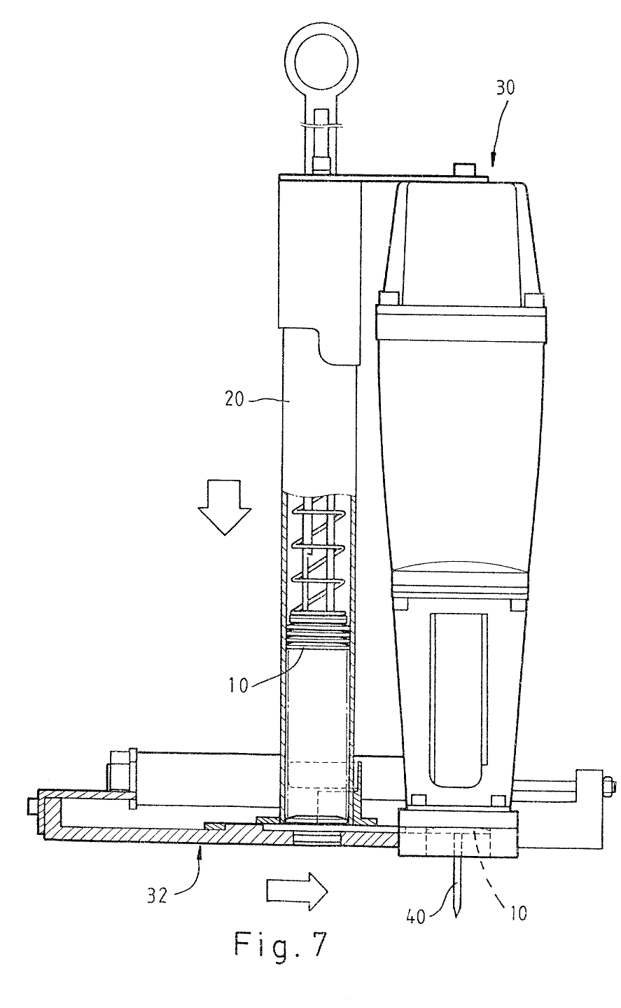

Referring to FIGS. 6 and 7, the operation of the invention will now be described. When the pneumatic nail gun 30 (i.e., a bias mechanism 31) is activated, the nail 40 is continuously cast out of washer receiving cylinder 20 through second stop member 22, third stop member 23, or fourth stop members 24 by a pneumatic delivery mechanism 32 wherein the tip of nail 40 passes through washer 10. Thus, a desired object may be fixed to the other one by the cast nail 40 and washer 10.

While the invention has been described by means of specific embodiments, numerous modifications and variations could be made thereto by those skilled in the art without departing from the scope and spirit of the invention set forth in the claims.

What is claimed is:

1. A washer feeding device attached to a nail gun, said washer feeding device comprising:
a hollow cylindrical washer receiving cylinder having a plurality of washers stacked therein, said washer receiving cylinder including a ring-like first stop member inwardly extended from a top edge thereof, wherein an inner diameter of said first stop member is smaller than a diameter of said washer by a predetermined value and a flexible second stop member at a bottom of the washing receiving cylinder;
a bias mechanism on said washer receiving cylinder for pressing a topmost washer downwardly; and
a pneumatic delivery mechanism for pushing a bottommost washer into said nail gun;
wherein said washers are prevented from dropping from either end of said washer receiving cylinder in storage and said washers are free to leave said washer receiving cylinder through said second stop member in operation.

2. The washer feeding device of claim 1, wherein said second stop member is substantially a U shape having both ends snapped to said circumferential surfaces of said washer receiving cylinder.

3. The washer feeding device of claim 1, wherein said second stop member is a ring-like member being inwardly extended from said bottom of said washer receiving cylinder wherein said inner diameter of said second stop member is smaller than said diameter of said washer by a predetermined value.

4. The washer feeding device of claim 1, wherein said second stop member includes a plurality of equally spaced flexible projections each inwardly extended from said bottom of said washer receiving cylinder by a predetermined distance.
